(19) United States
(12) Patent Application Publication
(10) Pub. No.: US 2014/0373428 A1
(43) Pub. Date: Dec. 25, 2014

(54) FISH HOOK HAVING NON-PLANAR PRONGS

(71) Applicant: Predator Hooks, LLC, Keller, TX (US)

(72) Inventor: Thoys D. Sanders, Fort Worth, TX (US)

(21) Appl. No.: 13/925,335

(22) Filed: Jun. 24, 2013

(51) Int. Cl. A01K 83/00; A01K 85/00

(52) U.S. Cl. CPC A01K 83/00; A01K 85/00
USPC 43/42.36; 43/44.82

(57) ABSTRACT

A fish hook includes a shaft having a first end, and a first plurality of prongs attached to the shaft a first distance from the first end. The fish hook also includes a second plurality of prongs attached to the shaft at a second distance from the first end, wherein the second distance is longer than the first distance.

### TECHNICAL FIELD

This disclosure relates generally to fish hooks. More specifically, this disclosure relates to a fish hook having multiple non-planar prongs.

### BACKGROUND

For thousands of years, fishing has provided a generous food supply for many cultures. People of all ages enjoy fishing, as a hobby, an occupation, or both. The use of one or more fish hooks at the end of a fishing line, with or without a lure, is a common element in both salt water and fresh water fishing. A typical fish hook includes an eyelet, a shaft, and at least one hook or prong with a curved portion and a point. Some hooks include multiple prongs.

### SUMMARY

This disclosure provides an advantageous fish hook having multiple non-planar prongs.

According to one embodiment of the present disclosure, a fish hook is provided. The fish hook includes a shaft having a first end, and a first plurality of prongs attached to the shaft a first distance from the first end. The fish hook also includes a second plurality of prongs attached to the shaft at a second distance from the first end, wherein the second distance is longer than the first distance.

In another embodiment, a fishing lure is provided. The fishing lure includes a lure body and at least one fish hook attached to the lure body. Each of the at least one fish hook includes a shaft having a first end, and a first plurality of prongs attached to the shaft a first distance from the first end. The at least one fish hook also includes a second plurality of prongs attached to the shaft at a second distance from the first end, wherein the second distance is longer than the first distance.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIGS. 1A through 1C illustrate perspective, side, and top views of a drop quad hook, according to an embodiment of this disclosure;

FIGS. 2A and 2B illustrate two drop quad hooks having different drops, according to embodiments of this disclosure;

FIG. 3 illustrates a top view of a drop quad hook having twisted prongs, according to embodiments of this disclosure; and

FIG. 4 illustrates a fishing lure that includes one or more drop quad hooks, according to an embodiment of this disclosure.

### DETAILED DESCRIPTION

The various embodiments used to describe the principles in this disclosure are by way of illustration only and should not be construed in any way to limit the scope of the disclosure. Those skilled in the art will understand that the principles of the disclosure may be implemented in any type of suitably arranged device or system.

Embodiments of this disclosure provide a fish hook that includes multiple prongs. Unlike the prongs in some fish hooks, the multiple prongs of the disclosed fish hook are placed in different horizontal planes along the shaft of the fish hook. That is, at least one first prong is attached to the hook further down the shaft of the hook than at least one second prong. In one embodiment, a “quad” fish hook includes four prongs, with two prongs “dropped” further down the shaft than the other two prongs. Such a hook may be referred to as a “drop quad hook”.

A drop quad hook is suitable and adaptable for fresh water fishing, sea water fishing, or both. The drop quad hook may be used for deep sea fishing or fishing in shallower water. As described herein, the drop quad hook may be scaled and adapted for almost any type of fishing while providing similar advantages for each type.

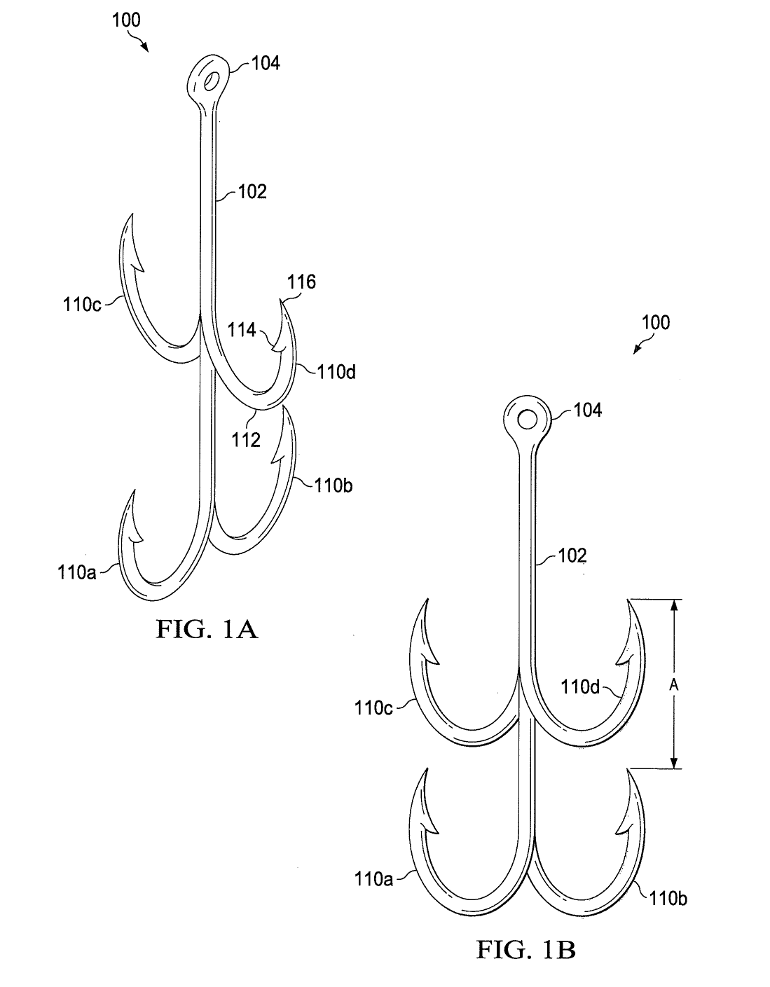

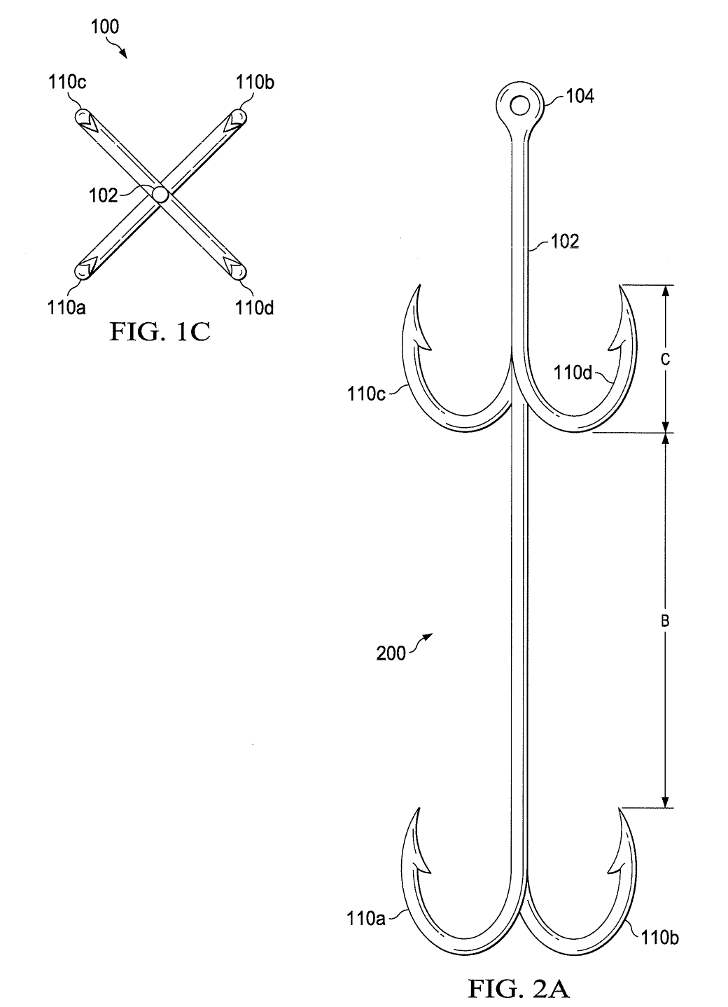

FIGS. 1A through 1C illustrate perspective, side, and top views of a drop quad hook, according to an embodiment of this disclosure. The embodiment of the drop quad hook 100 shown in FIGS. 1A through 1C is for illustration only. Other embodiments of the drop quad hook 100 could be used without departing from the scope of this disclosure.

As shown in FIGS. 1A through 1C, the drop quad hook 100 includes a shaft 102 with an eyelet 104 at one end of the shaft 102. Because the drop quad hook 100 is often oriented vertically in use with the eyelet 104 at the top, the end of the shaft 102 occupied by the eyelet 104 will be hereinafter referred to as the “top” end. At the other (i.e., “bottom”) end of the shaft 102 are two prongs 110a, 110b. Along the middle portion of the shaft 102 are two more prongs 110c, 110d. As shown in FIG. 1C, the prongs 110a-110d are arranged at approximately ninety degree intervals. Each prong 110a-110d includes a curved portion 112, a barb 114, and a point 116.

In an embodiment, the drop quad hook 100 is formed of one or more metal materials, such as surgical steel, stainless steel, or copper. The drop quad hook 100 may be formed of other materials, such as plastic or any other suitable material. The drop quad hook 100 may be formed in any color or with any design. In some embodiments, the drop quad hook 100 may be shiny and reflective, or may have a duller, more muted finish. In some embodiments, the drop quad hook 100 may be coated with another material, such as a plastic coating over a metal base.

The drop quad hook 100 may be scaled to any suitable size based on its particular application. For example, a bigger hook may be more useful for catching larger fish, while a smaller hook may be more suited to catching smaller fish. In one example embodiment, the drop quad hook is approximately 3½ inches long from the tip of the eyelet 104 to the bottom portion of the curve of the lower prongs 110a, 110b. The vertical distance A, or “drop”, between the points 116 of the upper and lower prongs is approximately one inch.

In one embodiment, each of the prongs 110a-110d is approximately the same size. In other embodiments, the prongs 110a-110d may have different sizes. For example, the upper prongs 110c, 110d could be a larger size, and the lower prongs 110a, 110b could be a smaller size, or vice versa. Any other combination of prong sizes may be suitable according to particular applications.

Bait can be applied to none, one, or a plurality of the prongs 110a-110d. For example, bait may be applied to only the upper prongs 110c, 110d or only the lower prongs 110a, 110b.

In use, the drop quad hook 100 is designed to increase the strike zone, thereby increasing the likelihood of a successful catch. For example, in one aspect of operation, when a fish encounters the drop quad hook 100, the fish opens its mouth around all of the prongs 110a-110d in an attempt to eat the bait on the prongs. As the fish closes its mouth on the drop quad hook 100, the lower prongs 110a, 110b are at a lower plane in the fish. As the fish pulls on the drop quad hook 100 or the fisherman pulls on the line, the drop quad hook 100 moves upward and outward from the fish's mouth. The upper prongs 110c, 110d may slip out of the fish's mouth, but the lower prongs 110a, 110b are still within the fish's mouth. The lower prongs 110a, 110b thus provide additional opportunities to hook a portion of the fish's mouth, thereby increasing the probability of a successful strike.

Although FIGS. 1A through 1C depict one example of a drop quad hook 100, various changes may be made to FIGS. 1A through 1C. For example, the vertical distance A, or “drop”, between the points 116 of the upper and lower prongs can vary according to different applications. This is described in greater detail below.

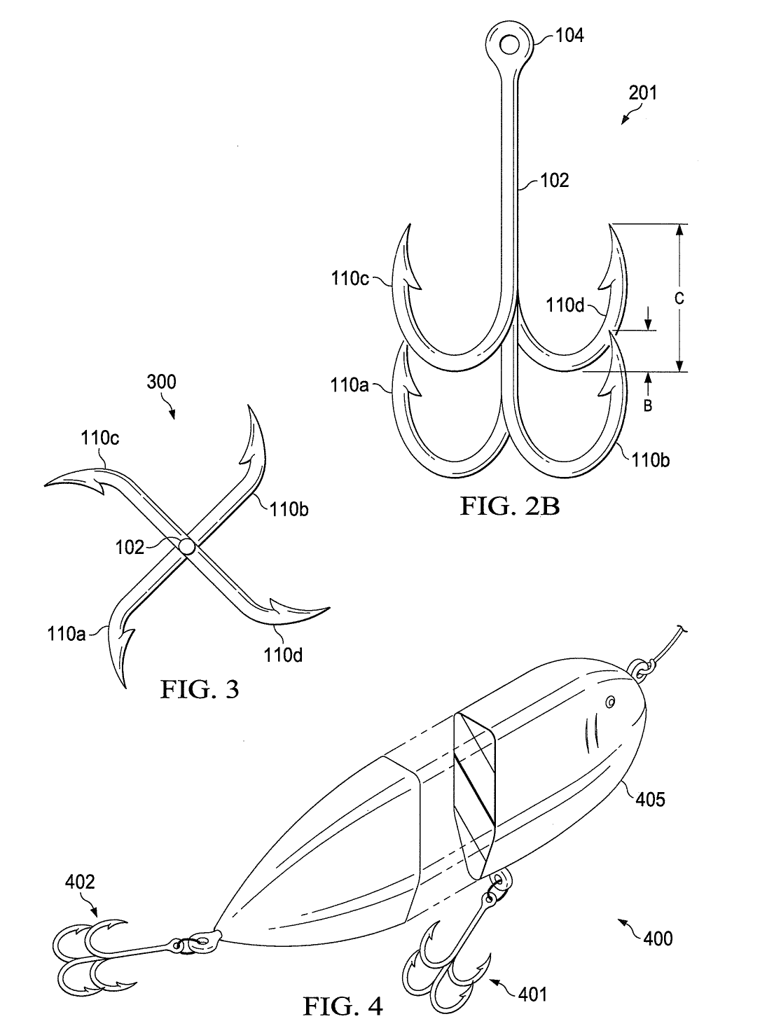

FIGS. 2A and 2B illustrate two drop quad hooks having different drops, according to embodiments of this disclosure. The embodiments of the drop quad hooks 200, 201 shown in FIGS. 2A and 2B are for illustration only. Other embodiments of the drop quad hooks 200, 201 could be used without departing from the scope of this disclosure.

As shown in FIGS. 2A and 2B, the drop can vary according to particular applications. In one embodiment, the drop is measured from the bottom of the curve of upper prongs 110c, 110d to the points of the lower prongs 110a, 110b (indicated by dimension B). In some embodiments, the drop B may be compared to the vertical dimension of the upper prongs 110c, 110d, as measured from the bottom of the curve to the point (indicated by dimension C).

In some embodiments, the drop may be expressed as a ratio of the dimension B to the dimension C. For example, if the dimension B is approximately 250% of the dimension C, as shown in the drop quad hook 200 in FIG. 2A, then the drop quad hook 200 is characterized as having a 250% drop. In contrast, in the drop quad hook 201 in FIG. 2B, the dimension B is approximately 25%, of the dimension C and the dimension B is vertically higher than the bottom of the curve of the upper prongs 110c, 110d. That is, the vertical dimensions of the upper and lower prongs overlap. In this case, the drop quad hook 201 in FIG. 2B is characterized as being 25% raised. Other drop quad hooks might have 0% separation. That is, the points of the lower prongs 110a, 110b are at the same vertical level as the bottom part of the curves of the upper prongs 110c, 110d. In other words, the dimension B is zero for a drop quad hook with 0% separation. It will be understood that other dimensions may be selected for particular applications.

Although FIGS. 2A and 2B depict examples of a drop quad hook having different drops, various changes may be made to FIGS. 2A and 2B. For example, the drops could be measured in different ways, such as in vertical separation between the points of the prongs, or vertical separation between the bottoms of the curves of the prongs.

FIG. 3 illustrates a top view of a drop quad hook having twisted prongs, according to embodiments of this disclosure. The embodiment of the drop quad hook 300 shown in FIG. 3 is for illustration only. Other embodiments of the drop quad hook 300 could be used without departing from the scope of this disclosure.

As shown in FIG. 3, the prongs 110a-110d of the drop quad hook 300 are “twisted” or offset from the vertical plane. That is, the twisted prongs 110a-110d are no longer completely in the same plane as the shaft 102. The amount of the twist may be approximately fifteen degrees (15°) for each of the prongs 110a-110d. In other embodiments, the amount of the twist may be anywhere between one degree and forty-five degrees (1°-45°). The amount of the twist may be less or more and may be selected according to particular applications.

In some embodiments, the twist of the prongs can be selected to create a spinning effect like a propeller when the drop quad hook is pulled through the water. In one example, the drop quad hook has a shiny appearance and is twisted. As it is pulled through the water, the drop quad hook spins and randomly reflects light, thus giving the appearance of a small fish moving through the water. This may attract other fish to the drop quad hook, thereby increasing the probability of a successful strike.

Although FIG. 3 depicts one example of a drop quad hook having twisted prongs, various changes may be made to FIG. 3. For example, the amount of the twist may be the same for each prong, or may vary between prongs. In one embodiment, the upper prongs 110c, 110d of the drop quad hook 300 are twisted and the lower prongs 110a, 110b are straight, or vice versa.

FIG. 4 illustrates a fishing lure that includes one or more drop quad hooks, according to an embodiment of this disclosure. The embodiment of the lure 400 shown in FIG. 4 is for illustration only. Other embodiments of the lure 400 could be used without departing from the scope of this disclosure.

As shown in FIG. 4, the lure 400 includes a lure body 405 that is attached to a line, and two drop quad hooks 401, 402. Each of the drop quad hooks 401, 402 may represent one of the drop quad hooks 100, 200, 201, 300 shown in FIGS. 1A through 3. The drop quad hooks 401, 402 may represent any other suitable drop quad hooks in accordance with this disclosure. The lure body 405 is shown in a cut away view to better illustrate the position of the drop quad hook 401.

Unlike treble hooks, which may tend to cradle the lure body when being pulled, the drop quad hook 401 provides lower prongs that drop down away from the lure body 405. In some embodiments, the drop quad hook 402 has twisted prongs that cause the drop quad hook 402 to spin when the lure 400 is being pulled. This gives the lure 400 a more lifelike appearance and eliminates the need for additional applications, spinners, or other equipment on the lure 400.

Although FIG. 4 depicts one example of lure with drop quad hooks, various changes may be made to FIG. 4. For example, the lure 400 may have any suitable size, shape, or appearance. As another example, the lure 400 may include more or fewer than two drop quad hooks. The drop quad hooks may be positioned in other locations on the lure 400.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A fish hook comprising:
a shaft having a first end;
a first plurality of prongs attached to the shaft a first distance from the first end; and
a second plurality of prongs attached to the shaft at a second distance from the first end, wherein the second distance is longer than the first distance.

2. The fish hook of claim 1, wherein each of the prongs comprises:
a curved portion extending away from the shaft of the fish hook; and
a point at an end of the curved portion.

3. The fish hook of claim 1, wherein the first plurality of prongs comprises two prongs and the second plurality of prongs comprises two prongs, and the four prongs are arranged at approximately ninety degree intervals around the shaft of the fish hook.

4. The fish hook of claim 3, wherein the points of the second two prongs are at a same vertical level as a bottom part of the curved portion of the first two prongs.

5. The fish hook of claim 3, wherein the points of the second two prongs are at a vertical level lower than a bottom part of the curved portion of the first two prongs.

6. The fish hook of claim 3, wherein the points of the second two prongs are at a vertical level higher than a bottom part of the curved portion of the first two prongs.

7. The fish hook of claim 3, wherein at least one of the four prongs is twisted at an angle from a vertical plane shared with the shaft of the fish hook.

8. The fish hook of claim 1, further comprising an eyelet at the first end of the shaft.

9. The fish hook of claim 1, wherein the fish hook is formed of stainless steel or surgical steel.

10. The fish hook of claim 1, wherein the fish hook is formed of plastic.

11. A fishing lure, comprising:
a lure body; and
at least one fish hook attached to the lure body, each of the at least one fish hook comprising:
a shaft having a first end;
a first plurality of prongs attached to the shaft a first distance from the first end; and
a second plurality of prongs attached to the shaft at a second distance from the first end, wherein the second distance is longer than the first distance.

12. The fishing lure of claim 11, wherein each of the prongs comprises:
a curved portion extending away from the shaft of the fish hook; and
a point at an end of the curved portion.

13. The fishing lure of claim 11, wherein the first plurality of prongs comprises two prongs and the second plurality of prongs comprises two prongs, and the four prongs are arranged at approximately ninety degree intervals around the shaft of the fish hook.

14. The fishing lure of claim 13, wherein the points of the second two prongs are at a same vertical level as a bottom part of the curved portion of the first two prongs.

15. The fishing lure of claim 13, wherein the points of the second two prongs are at a vertical level lower than a bottom part of the curved portion of the first two prongs.

16. The fishing lure of claim 13, wherein the points of the second two prongs are at a vertical level higher than a bottom part of the curved portion of the first two prongs.

17. The fishing lure of claim 13, wherein at least one of the four prongs is twisted at an angle from a vertical plane shared with the shaft of the fish hook.

18. The fishing lure of claim 11, further comprising an eyelet at the first end of the shaft.

19. The fishing lure of claim 11, wherein the fish hook is formed of stainless steel or surgical steel.

20. The fishing lure of claim 11, wherein the fish hook is formed of plastic.
